(19) United States
(12) Patent Application Publication
(10) Pub. No.: US 2023/0254623 A1
(43) Pub. Date: Aug. 10, 2023

(54) EARPHONE

(71) Applicant: Audiolineout LLC, Portland, OR (US)

(72) Inventors: Ben Loeliger, Portland, OR (US); Valivann Seangly, Portland, OR (US); Caleb Rosenau, Portland, OR (US); Kenneth Ball, Portland, OR (US)

(73) Assignee: Audiolineout LLC, Portland, OR (US)

(21) Appl. No.: 17/665,989

(22) Filed: Feb. 7, 2022

(51) Int. Cl. H04R 1/10

(52) U.S. Cl. CPC H04R 1/1016; H04R 2460/11

(57) ABSTRACT

Innovations for an improved earphone design are provided. The earphone includes an earphone body with three or more acoustic drivers disposed substantially congruently about an axis. One or more acoustic drivers included in the earphone body include a first, sound emitting, end and a second opposing end. A vent is defined in a compartment in which the acoustic driver is received and is coaxial to an axis passing through the first and second ends of the acoustic driver.

### FIELD

The present disclosure relates to earphones and methods of their design. Particular embodiments provide earphone bodies with vents formed proximate a perimeter of one or more acoustic drivers, a plurality of acoustic drivers disposed congruently about an axis, or both.

### BACKGROUND

In-ear headphones or monitors are physically small devices. Given the small interior volume of an earphone body, it can be challenging to incorporate multiple acoustic drivers into an earphone. In addition, it can be difficult to create earphones with different or improved acoustic properties given the small interior volume of an earphone body. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Innovations for an improved earphone design are provided. The earphone includes an earphone body with three or more acoustic drivers disposed substantially congruently about an axis. One or more acoustic drivers included in the earphone body include a first, sound emitting, end and a second opposing end. A vent is defined in a compartment in which the acoustic driver is received and is coaxial to an axis passing through the first and second ends of the acoustic driver. Although the substantially congruently arranged acoustic drivers and the vent can be used in combination, these innovations also may be used independently of one another.

In one embodiment, the present disclosure provides an earphone having an earphone body. Three or more acoustic drivers are disposed in the earphone body and are substantially congruently disposed about a central axis. In a particular implementation, the acoustic drivers have sound emitting ends and such ends are disposed inwardly towards the central axis. The number of acoustic drivers is three in a particular example, where the acoustic drivers have midpoints (or centers) that are disposed substantially 120° apart from one another about the central axis.

In another particular implementation, the acoustic drivers are disposed in a tuning armature. The tuning armature in turn can be secured within the earphone body. If desired, the earphone can include one or more additional acoustic drivers that are not located with the tuning armature or are not disposed about the central axis (whether or not a tuning armature is used).

In another embodiment, the present disclosure provides an earphone having an earphone body. The earphone further includes a compartment within the earphone body for receiving an acoustic driver. An acoustic driver is disposed within the compartment and has a first, sound emitting, end and an opposing second end. The acoustic driver has lateral sides orthogonal to the first end and the second end. A vent is defined in the compartment and is coaxial to an axis passing through the first end and the second end of the acoustic driver. In one example, the vent is disposed at least partially about the perimeter of the acoustic driver. In another example, the vent is disposed adjacent to the perimeter of the acoustic driver, such as being located in front of the first end of the acoustic driver.

In particular examples, the vent is in fluid communication with a sound bore that connects the vent with an opening in the earphone body configured to be placed in a user's ear.

The foregoing and other objects, features, and advantages of the invention will become more apparent from the following detailed description, which proceeds with reference to the accompanying figures.

### BRIEF DESCRIPTION OF THE DRAWINGS

FIGS. 1A-1F are cross-sectional views of three-dimensional virtual models of an earphone body, earphone components, and sound modifying or transmitting features that can be included in an earphone, illustrating how such virtual models can be used in creating a model of an earphone body that can be used in manufacturing processes such as 3D printing or injection molding.

FIG. 2A is a cross-sectional view of an earphone having an earphone body and a cap, where the earphone includes a dynamic driver, a sound bore, and a vent.

FIG. 2B is a perspective, exploded view of the earphone of FIG. 2A, including showing a representation of negative space corresponding to the dynamic driver, sound bore, and vent.

FIG. 2C is a perspective view of the representation of negative space shown in FIG. 2B.

FIG. 2D is a top plan view of the representation of negative space shown in FIG. 2B.

FIG. 2E is a side elevational view of the earphone body and cap shown in FIG. 2B.

FIG. 2F is a cross-sectional view taken along line C-C of FIG. 2E.

FIG. 3A is a cross-sectional view of an earphone having an earphone body and a cap, where the earphone includes a plurality of balanced armature drivers, a plurality of sound bores, and a plurality of sound chambers.

FIG. 3B is a perspective, exploded view of the earphone of FIG. 3A, including showing a representation of negative space corresponding to the balanced armature drivers, sound bores, and sound chamber.

FIG. 3C is a perspective view of the representation of negative space shown in FIG. 3B.

FIG. 3D is a top plan view of the representation of negative space shown in FIG. 3B.

FIG. 3E is a side elevational view of the earphone body and cap shown in FIG. 3B.

FIG. 3F is a cross-sectional view taken along line C-C of FIG. 3E.

FIG. 4 is a cross-sectional view of an earphone having an earphone body and a cap, where the earphone includes a dynamic driver, a plurality of balanced armature drivers, a plurality of sound bores, a plurality of sound chambers, and a vent.

FIG. 5 is a flowchart of an example method for manufacturing an earphone having a solid body.

FIG. 6A is a perspective view of an earphone having a vent extending around or proximate the perimeter of an acoustic driver.

FIG. 6B is a top plan view of the earphone of FIG. 6A, with the acoustic driver removed.

FIG. 6C is a perspective, cross-sectional view of the earphone of FIG. 6A, with the acoustic driver removed, taken along the line A-A of FIG. 6B.

FIG. 6D is an elevational cross-sectional view of the earphone of FIG. 6A, with the acoustic driver removed, taken along the line A-A of FIG. 6C.

FIG. 6E is a top plan view of the earphone of FIG. 6A.

FIG. 6F is a perspective, cross-sectional view of the earphone of FIG. 6A taken along the line B-B of FIG. 6E.

FIG. 6G is an elevational cross-sectional view of the earphone of FIG. 6A taken along the line B-B of FIG. 6E.

FIG. 6H is another perspective view of the earphone of FIG. 6A.

FIG. 6I is a cross-sectional view of the earphone of FIG. 6H taken alone the line C-C of FIG. 6H.

FIG. 7A is a perspective view an earphone having two acoustic drivers in communication with a slot extending about the perimeter of the acoustic drivers through radial vents.

FIG. 7B is a cross-sectional view of the earphone of FIG. 7A taken along line A-A.

FIG. 7C is a cross-sectional view of the earphone of FIG. 7B taken along line B-B.

FIG. 7D is a perspective, cross-sectional view of the earphone of FIG. 7B taken along line B-B.

FIG. 7E is an elevational, cross-sectional view of the earphone of FIG. 7B taken along line C-C.

FIGS. 7F and 7G are, respectively, perspective and elevational, cross-sectional views of the earphone of FIG. 7B taken along line C-C.

FIG. 8A is a perspective view of an earphone having a plurality of acoustic drivers congruently arranged about an axis.

FIG. 8B is a cross-sectional view of the earphone of FIG. 8A taken along the line A-A.

FIG. 8C is a top plan view of a driver armature than can be used to hold the acoustic drivers of FIG. 8A.

FIG. 8D is a cross-sectional view of the driver armature of FIG. 8C taken along the line C-C.

FIG. 8E is a cross-sectional view of the driver armature of FIG. 8C taken along the line B-B.

FIG. 9A is perspective view of an alternate driver armature than can be used in conjunction with an earphone configured as, or similar to, the earphone of FIG. 8A.

FIG. 9B is a perspective cross-sectional view of the driver armature of FIG. 9A taken along the line B-B.

FIG. 9C is a cross-sectional view of the driver armature of FIG. 9A taken along the line A-A.

FIG. 9D is a bottom plan view of the driver armature of FIG. 9A.

### DETAILED DESCRIPTION

### Example 1—Overview

The design and fabrication of electronic devices to be used in small operating environments can be challenging. For example, earphones are required to include drivers and various sound channels in a very small space—particularly for in-ear earphones. Tradeoffs often arise between considerations such as sound quality, durability, and ease of manufacturing. Accordingly, room for improvement exists.

Housings are commonly provided having a plurality of separable portions, such as a portion of the housing that includes a tip (or earpiece or spout) to be inserted into the user's ear, and portion of the housing that will face outwardly, and be maintained within structures of the outer ear such as the tragus, antitragus, concha, and crus helix. During manufacturing, the drivers and other electronic components are typically secured in a cavity formed in a first portion of the housing. Clips or other securing means can be included in the first housing portion in order to secure the drivers or other components in place. A second housing portion can be secured over the open side of the first housing portion, such as using a snap or friction fit, including by inserting a gasket or other sealing means between coapting ends of the first and second housing portions. Other means of securing or sealing the two housing portions can be used, such as using adhesives or by fusing (e.g., thermally) a seam formed at the juncture of the housing portions.

While above-described methods of assembling earphones can be acceptable in some cases, such as to mass produce large quantities of standard earphones having acceptable sound quality, they can be problematic. For example, when one or more portions of an earphone housing include relatively larger cavities, the acoustic properties of the earphones can suffer. In addition, clips or other means used to secure drivers and other components within the housing can be prone to breakage, or to having the components slip outside of the clips, particularly if they are adjacent to open space within the cavity. Thus, earphones made using traditional techniques can suffer from durability issues, particularly if dropped or otherwise subjected to impact forces.

Similar issues can arise when tubes are used in an earphone. In a particular design, a portion of the housing may have interior passages that lead between an interior portion of the housing and an exterior portion of the housing. For example, a portion of the housing intended to be inserted into a user's ear canal can have one or more passages that extend from the inside of the housing to the exterior of the housing in order to transmit sound to the user. Tubes, including flexible tubes, may be used to couple the passage to a physical component, such as a driver, located in the cavity of the housing. These tubes can become disconnected or dislodged, which can affect sound quality, and more typically results in the earphones being unusable.

The components, and manufacturing techniques, typically used for earphones also can limit the sound reproduction properties of the earphones. For example, as mentioned, a large cavity may have undesirable acoustic properties, and tubes may be used to more precisely transmit sound from sound-generating components of the device to the user's ear. However, there are typically a limited number of properties of the tubes than can be modified in order to adjust their acoustic properties. Tube properties such as the diameter of the tube, the shape of the ends of the tube (used to attach to other structures of the earphones), and the material from which the tube is constructed may be modified to an extent. However, even potential changes to these properties can be constrained by limitations in the volume of the cavity, space taken by other components, and the length of the tube, and any curvature, needed to couple the different components. Moreover, the length of the tube, apart from perhaps one or both of the ends, typically has a substantially constant diameter, and the ability to bend or shape the tube can be limited.

The present disclosure provides innovations that can help address some of the issues with prior earphone designs. In one aspect, the present disclosure provides an earphone that has one or more vents formed about a circumference of one or more acoustic drivers. The vents can create a larger volume of air surrounding such acoustic drivers, which can provide different acoustic properties for the earphone, such as altering the sound stage. For example, the sound stage can be larger—such sounding as if the sound was present in a larger area/having more separation between different musical components.

Such a design can also allow more flexibility in earphone design, including providing more flexibility in the orientation of the driver(s). For example, a driver does not have to be placed such that the sound output from the driver is in line with an output end of the earphone leading to a user's ear. Instead, the driver can be placed at an angle, including 45° or 90°, relative to a location of an exit port/earphone earpiece.

In some cases, the vent is referred to a radial vent, which can refer to the venting being radial relative to an axis passing through a sound-transmitting portion of an acoustic driver. Radial venting can have additional advantages, including being able to reduce the size of an earphone, including because of the additional design flexibility noted above. Radial venting can also be beneficial in that larger drivers can be use in an earphone, a larger number of drivers can be included in an earphone, or the placement of non-radially vented drivers relative to the radially vented drivers can be made more flexible.

In another aspect, the present disclosure provides earphones that have a plurality of acoustic drivers congruently disposed about an axis. By congruently, it is meant that the acoustic drivers are equally or substantially equally disposed about the axis. In this context, “substantially” means that the acoustic drivers are disposed with respect to one another at angles that are within 10% or less of one another, such as 5% or 2% or less of one another. In a specific embodiment, three acoustic drivers are disposed about the axis, and the angle between pairs of acoustic drivers is, or is substantially, 120° (plus or minus 12°, for example).

In another particular embodiment, the sound emitting faces of the acoustic drivers point inwardly toward the axis. A portion of the earphone along the axis can be open and can form a sound chamber or sound bore that communicates with other portions of the earphone, including an earpiece.

The acoustic drivers can be positioned within a body of the earphone in a variety of ways, including by disposing each acoustic driver in a compartment within the earphone housing that maintains the respective acoustic driver in the appropriate position. In another implementation, the acoustic drivers are placed within a driver armature, and the driver armature can be installed within the earphone body.

This aspect of the present disclosure can provide a number of advantages. For example, by placing the acoustic drivers at appropriate angles with respect to one another, interference between the magnetic fields of adjacent acoustic drivers can be reduced. Reduced magnetic interference can improve the stability of the audio signal and provide a more pleasing frequency response. This benefit can allow more acoustic drivers to be included in an earphone, or an equivalent number of acoustic drivers to be placed within a smaller volume of the earphone body (i.e., increasing the surface area of acoustic drivers within a given area/driver unit/earphone body).

Although the above described aspects of the present disclosure have been described separately, and will be further described in separate examples, these innovations can be used together—an earphone having radial vents and congruently disposed acoustic drivers.

The innovations can be included in a variety of earphone designs, including hollow earphone bodies having tubes connecting various components or in solid earphone bodies where at least some structures, such as tuning chambers or sound bores, are formed within a solid earphone body. Having a solid earphone body can provide additional advantages, as further described below. For example, a solid earphone body can address some or all of the problems in prior earphone designs, as well as methods of designing and manufacturing such earphones. One disclosed technology provides an earphone with a solid body that includes one or more negative spaces, or receptacles, for receiving hardware components of the earphone, such as a driver. A negative space for a hardware component can be configured to securely retain the hardware component within an assembled earphone. In some cases, the hardware component can be secured without the need for additional securing elements, such as adhesives or clips.

For example, if a hardware component has a plurality of sides, or edges (e.g., for a circle, edges can be considered points connected by a diameter of the circle), the negative space can be configured to receive at least one less than the plurality of sides, with material of the solid body contacting the received sides. At least one side of a hardware component (which can be an acoustic driver that is congruently disposed about an axis with other acoustic drivers, a radially vented acoustic driver, or both) is received by a negative space, and is contacted by surrounding material of the solid body. In further cases, at least two sides of the component are received by the negative space, and is contacted by surrounding material of the solid body. Generally, a negative space for receiving a hardware component has an exterior end and an interior end, where the exterior end defines an opening for receiving the hardware component.

Another earphone can have a solid body defining negative spaces in the form of tunnels or through holes that connect earphone hardware components to an exterior surface of the earphone, such as for transmitting sound to a user. These types of tunnels or through holes are generally referred to herein as sound bores. The tunnels can also be used to interconnect hardware components, or acoustic features of the earphone, including features defined by negative spaces within a solid body of the earphone.

The tunnels can include (either integrally or being coupled to) one or more sound chambers, in the form of larger diameter negative spaces that are formed at intermediate sections of the tunnels, or at an end of a tunnel. Tunnels can also be present in the form of vents, such as vents used to adjust pressure in the earphone (including when worn by a user), or to adjust acoustic properties of the earphone.

As used herein, tunnels, including sound bores and vents, and sound chambers, are negative spaces with a solid earphone body. Tunnels are distinguished from tubes, where tubes consistent of a lumen defined by tube surface, where the outer surface of the tube is not surrounded by solid material. In particular examples, the disclosed tunnels extend through the body of the earphone and are surrounded by the solid portion of the earphone body for their entire length. However, in some cases, tubes can be inserted through all or a portion of the disclosed tunnels.

In a particular implementation, a disclosed earphone includes a generally solid body, defining negative spaces for hardware components, tunnels, or both, and forms a unitary surface. That is, the solid body is free of seams and is constructed as an integral, unitary mass of material. In particular examples, a solid earphone body, when drivers and other physical components have been installed into negative spaces formed in the earphone body, includes less than about 25% of unfilled space (e.g., non-solid material) compared with the total volume of the earphone body, such as less than about 20%, less than about 15%, less than about 10%, or less than about 5% of unfilled space. In particular examples, “about” means within 10% of the recited number. In further examples, an earphone body includes less than 25% of unfilled space, such as less than 20%, less than 15%, less than 10%, or less than 5%.

In further examples, a solid earphone body, when drivers and other physical components have been installed into negative spaces formed in the earphone body, is substantially free of unfilled space other than space associated with tuning elements (e.g., sound bores, vents, and sound chambers, or other negative-space features, where tuning elements more generally can include features such as acoustic damper). Substantially free of unfilled space, in this context, can mean less than about 15% of unfilled space compared with the total volume of the earphone body, such as less than about 12%, less than about 10%, less than about 8%, less than about 5%, or less than about 2% of unfilled space. In particular examples, “about” means within 10% of the recited number. In further examples, an earphone body includes less than 15%, 12%, 10%, 8%, 5%, or 2% of unfilled space.

The solid body can define an opening that provides access to negative spaces formed in the solid body. After hardware components are inserted into the earphone, a cap or plug can be placed over the opening. In particular implementations, compared with the overall surface area of the earphone body, the opening is less than about 25% of the total surface area, such as less than about 20%, less than about 15%, less than about 10%, or less than about 5% of the total surface area. In particular examples, “about” means within 10% of the recited number. In further examples, the opening is less than 25% of the total surface area of the earphone body, such as less than 20%, less than 15%, less than 10%, or less than 5% of the total surface area. However, in other implementations, the opening can be 20% or more of the total surface area of the earphone body.

According to a disclosed method, modeling software can be used to create negative spaces within a three-dimensional representation of a solid earphone body. The negative spaces can include tunnels or through holes, negative spaces for hardware (including acoustic driver arranged according to disclosed embodiments), or a combination thereof, as described above. The solid earphone body can be a standardized body that will be mass produced, or can be a custom body that can be adapted for the particular ear shape of an individual end user. Three-dimensional designs produced by modeling negative spaces in a solid earphone body can be fabricated into solid components using techniques such as 3D printing or injection molding.

Compared with prior approaches, the innovative disclosed earphones having solid earphone bodies can be faster and easier to manufacture, in that fewer parts (e.g., tubes) may be needed, and installation of hardware components can be facilitated by having custom negative spaces (or voids) for receiving them. Having components secured within negative spaces, and/or fewer components, can make the earphones more robust, such as being better able to withstand both normal handling, and accidents involving sharp impacts, without internal parts becoming dislodged. Further, flexibility in placing internal earphone components, and the shape and position of tunnels, include the fabrication of chambers intermediate or at an end of one or more tunnels, can allow for better earphone performance, and the design of features that can improve sound quality.

One or more of these benefits can be achieved with a design process that it is easily adaptable, such as to provide different general earphone designs (e.g., different hardware and/or acoustic channel designs), or to facilitate adapting an earphone design to the ear shape of a particular user.

### Example 2—Method of Designing and Fabricating an Earphone with a Solid Body

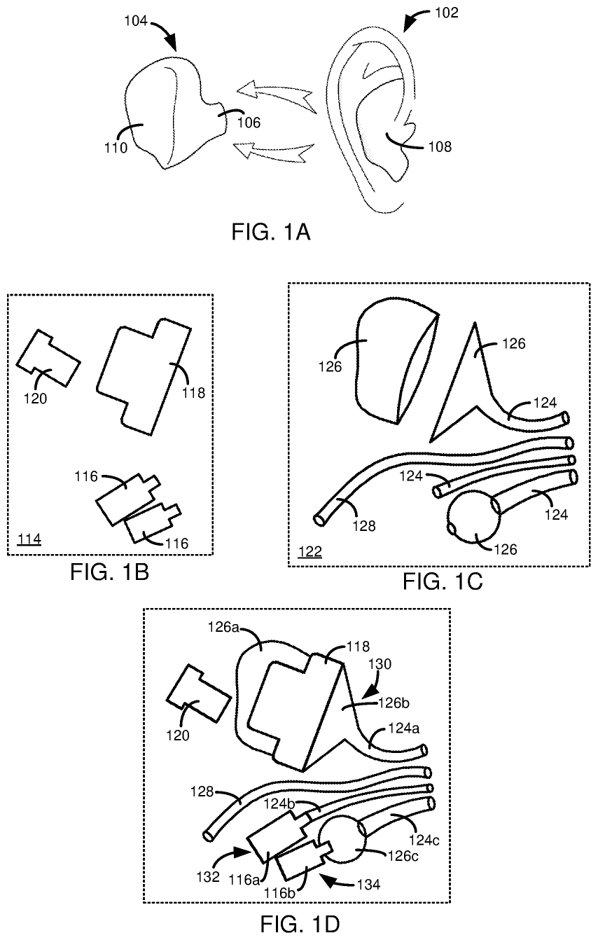

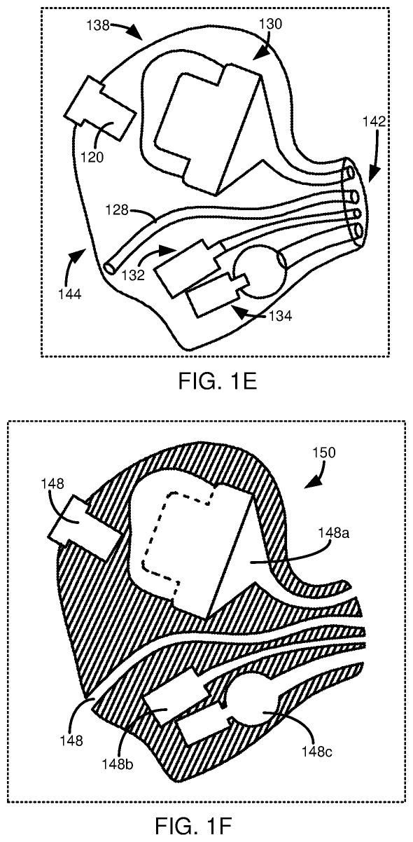

FIGS. 1A-1F are a series of schematic drawings illustrating components of an earphone according to disclosed embodiments, and how an earphone can be designed and constructed. FIG. 1A illustrates an earphone body 104 having a first end 106, configured to be inserted into the ear canal 108 of a user's ear 102, and a second, opposing, end 110, typically configured to be retained in the ear by physical structures of the user's outer ear.

In some cases, the earphone body 104 can be molded from, or otherwise represent, the anatomical features of an individual user's ear. For example, a mold or impression can be made of the user's ear, and converted to a three-dimension representation in a software design program, such as AUTODESK INVENTOR or FUSION 360 (both available from Autodesk, Inc., of San Rafael, Calif., and which can be used for the remaining steps associated with FIGS. 1A-1F). In other cases, a three-dimensional representation of the user's ear can be obtained by digitally scanning the user's ear. In further cases, the earphone body 104 can represent a standardized shape that is designed to satisfactorily fit any user, or at least a majority of users.

The first end 106 of the earphone body is typically shaped to securely, but comfortably, fit within the ear canal 108. In the case of earphone bodies 104 that are not customized, and intended to be used with many different users, the first end 106 can be covered with a tip, typically of rubber or another elastomer, that helps secure the earphone body 104 within the ear, while maintaining user comfort. In addition to helping secure the earphone body 104 in position, a secure fit within the ear canal 108, either through custom fitting or tips, can help improve the sound quality of the earphone, such as by reducing leakage of sound outside the earphone body, and helping reduce the intrusion of external sounds into the user's ear 102.

In a similar manner, the second end 110 is typically configured to help secure the earphone body 104 in position by nestling between, or wedging against, natural anatomic structures of the outer ear. Custom molded earphones can include a second end 110 that is also shaped to mate with native ear anatomy of a particular user. Mass produced, or general purpose, earphones can have a second end 110 that is shaped to mate with a variety of ear shapes.

FIG. 1B illustrates outline representations of various hardware components 114 that can be used in an earphone. The outline representations can be two or three-dimensional representations of physical hardware components 114 that will be used in an earphone. In some cases, the outline representations can be obtained by scanning the actual hardware components 114. In other cases, the outline representations can be manually created, and can approximate the actual shape of the hardware components 114. For example, many hardware components 114 are rectangular, or include rectangular portions, or are circular, or include circular portions, that are easily created using modelling software.

The hardware components 114 can include sound drivers (i.e., acoustic drivers), such as balanced armature drivers 116 and a dynamic driver 118. Hardware components 114 can further include a cable socket 120, which can be used to deliver electrical signals to the drivers 116, 118, to power the drivers and produce sound to be rendered to a user.

FIG. 1C illustrates outline representations of sound modifying and transmission structures 122 that can be included in an earphone, and can be represented in design software. The sound modifying structures and transmission structures 122 can include sound bores 124, acoustic chambers 126, and vents 128. Sound bores 124 can transmit sound from the drivers 116, 118 to the user's ear. Vents 128 can be used to allow air movement within the user's ear, or within the earphone, which can be used to tune the acoustic properties perceived by the user (e.g., to enhance bass). Similarly, acoustic chambers 126 can be used to condition sound to be transmitted to a user, and improve overall audio quality. Note that the acoustic chambers 126 can be a significant advantage of disclosed technologies, as typical methods of earphone production are not capable of incorporating acoustic chambers into an earphone body.

The representations of the hardware components 114 and the representations of the sound modifying and transmission structures 122 in modelling software can be used to generate negative spaces. That is, the representations themselves can indicate negative space, or can represent positive structures that are subtracted from a model (such as a model of the earphone body 104) in order to create negative spaces in the model.

FIG. 1D illustrates how the representations of the hardware components 114 and the sound modifying and transmission structures 122 can be arranged to form subassemblies, such as in a modelling software program. As shown, a subassembly 130 is formed by placing the dynamic driver 118 intermediate an acoustic chamber 126a and an acoustic chamber 126b, where the acoustic chamber 126b communicates with a sound bore 124a. Note that the end of the sound chamber 126b proximate the dynamic driver 118 has an enlarged opening, like a funnel, in order to capture sound transmitted by the dynamic driver, but tapers to a significantly narrower diameter in adjoining/transitioning into the sound bore 124a, which then passes though the earphone body 104 (FIG. 1A) towards the first end 106.

A subassembly 132 includes a balanced armature driver 116a proximate a sound bore 124b, while a subassembly 134 includes a balanced armature driver 116b proximate a sound chamber 126c, which in turn is proximate an end of a sound bore 124c. Note that while sound bores 124 and sound chambers 126 are shown as separate components, they can be treated (including being modelled) as unitary components. For example, in a solid body of a physical earphone, a sound bore may have an acoustic chamber at an end, or at an intermediate portion. In a corresponding model from which the physical earphone was created, the combined sound bore/acoustic chamber can be represented as an acoustic chamber overlying a sound bore, or a portion of the sound bore can be manipulated (e.g., stretched, or otherwise having a larger diameter than a remainder of the sound bore) to represent the acoustic chamber. The two modelling approaches can be considered equivalent from the standpoint of the physical solid earphone body.

In some cases, the virtual representations of one or more of the hardware components 114, the sound modifying and transmission structures 122, or the subassemblies 130, 132, 134 can be stored. For example, a variety of earphone models, either custom or standardized, can be created from different combinations of hardware components 114. At least many of the sound modifying and transmission structures 122 can also be standardized, or at least substantially standardized. That is, for example, the length and conformation of a particular sound bore 124 can be reasonably consistent between earphone models or custom versions of a specific model, with minor changes to length and/or orientation being made to adapt to changes in the size or shape of the solid earphone body 104 or the particular hardware components 114 being used, and the particular location and orientation thereof.

FIG. 1E illustrates how the subassemblies 130, 132, 134 can be incorporated into a virtual model 138 of an earphone body, such as the earphone body 104. The subassemblies 130, 132, 134 can be positioned within the model 138 in order to achieve desired acoustic properties, and to accommodate other hardware components of the earphones, such as the cable socket 120, and other sound modifying or transmitting features (e.g., sound bores, sound chambers, or vents), such as the vent 128. For example, the sound bores 124 and the vent 128 are positioned such that their ends extend to open at a first end 142 of the virtual model 138, corresponding to the first end 106 of the earphone body 104. The hardware components 114, including the drivers 116, 118 are placed towards a second end 144 of the virtual model 138, corresponding to the second end 110 of the earphone body 104, where there is a greater interior volume to house the components. The cable socket 120 is also placed at the second end 144 of the virtual model, to allow electrical connection with internal components of the earphone body, such as acoustic drivers.

FIG. 1F illustrates a cross-section of a solid earphone body 150 produced using the virtual model of FIG. 1E. The hardware components 114 and sound modifying and transmission structures 122 included in the virtual model 138 are represented as negative spaces 148 (shown as 148a-148c) in the solid earphone body 150.

In FIG. 1F, some of the negative spaces are shown as connecting, which others are shown as disconnected/non-contiguous. For example, the entire negative spaces 148a-148c for each subassembly 130, 132, 134 are shown as individually contiguous, but each of those negative spaces is shown as disconnected from the other. At least a portion of the negative spaces 148 may be disconnected, but, in practice, at least a portion of the negative spaces can be connected, but such connection is not shown in the particular cross-section of FIG. 1F.

In some cases, two or more negative spaces in an earphone body can be disconnected. However, it can be beneficial to have the negative spaces for multiple components be connected. In particular, it can be beneficial to have negative spaces 148 corresponding to at least a portion of the hardware component 114 connected, as this can facilitate manufacturing of an earphone, as will be further described.

In practice, a user can design an earphone by creating or loading (e.g., selecting saved components from a menu) a virtual model 138 of an earphone, the virtual models of the desired hardware components 114, and the virtual models of the sound modifying and transmission components 122, including as incorporated in subassemblies (e.g., subassemblies 130, 132, 134). After the hardware components 114 and sound modifying and transmission components 122 have been appropriately positioned, the components can optionally be converted to negative representations (i.e., if the representations were not already negative representations) such that the volume for these components is subtracted from portion of the virtual model 138 representing solid material, thus defining negative spaces (e.g., negative spaces 148) corresponding to the components. An earphone according to the model can then be fabricated, such as by injection molding or 3D printing.

However, various modifications can be made to the above-method. For example, an earphone design or manufacturing process can include carrying out one or more, including all, of the steps associated with FIG. 1B, FIG. 1C, or FIG. 1D. After the virtual models of the relevant hardware components and/or sound modifying or transmission components have been created, including as parts of subassemblies, a virtual model of an earphone body can be created, as described with respect to FIG. 1A, and the process can then continue as described with respect to FIG. 1E and FIG. 1F.

For example, in many cases, it can be beneficial to first design subassemblies of an earphone to achieve desired performance/acoustic properties, including a selection of hardware components and tuning elements. That particular collection of components and tuning elements can then be incorporated into one or more earphone body shapes as desired. In some cases, minor adjustments, such as to the length and conformation of tuning elements, can be made to adapt a particular earphone design to a particular body shape.

### Example 3—Example Solid Body Earphones

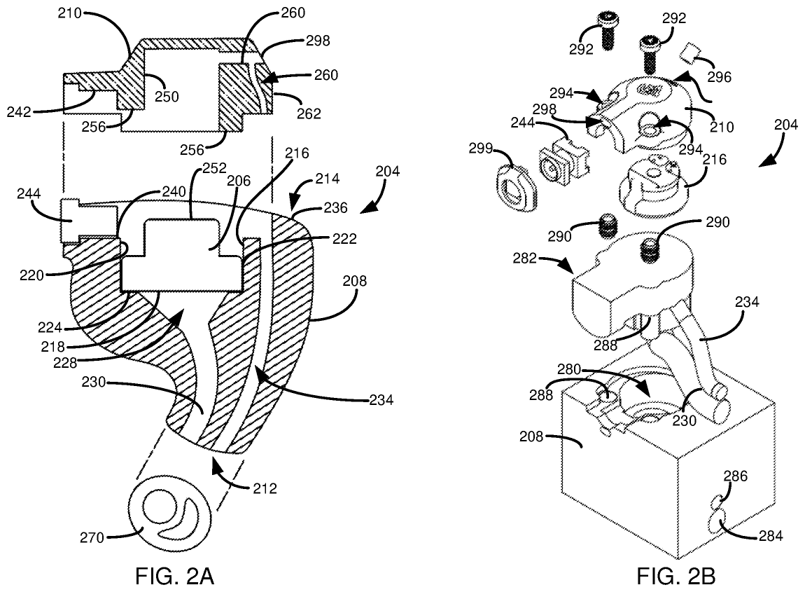

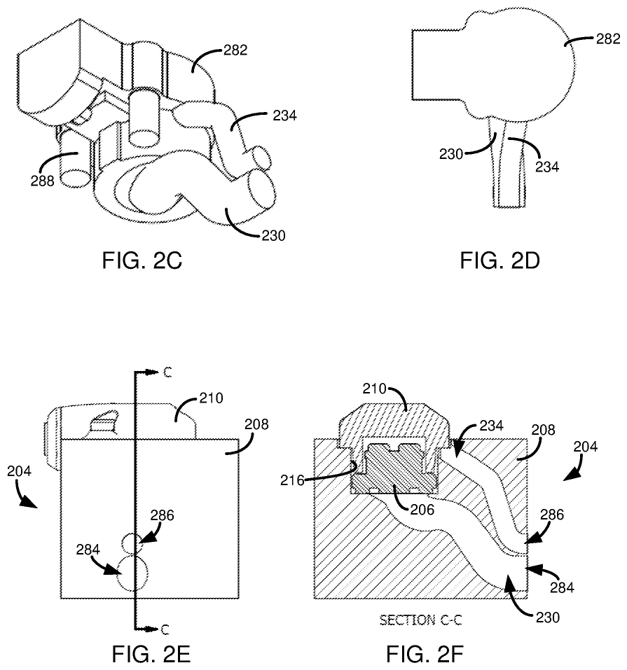

FIGS. 2-4 illustrate different earphone designs that can be produced using the technique described in conjunction with FIGS. 1A-1F. The different earphone designs can represent designs that allow different acoustic properties to be achieved, as well as earphones meeting different price/performance objectives.

FIG. 2A illustrates a cross-sectional view of an earphone 204 that includes a single dynamic driver 206. The earphone 204 is formed from a unitary body 208, onto which a cap 210 can be placed. Both the body 208 and the cap 210 can incorporate negative spaces, both to house hardware components and to allow for sound modification or transmission. The body 208 includes a first end 212 that is configured to be placed in the user's ear. The body 208 includes a second end 214, where the second end is completed when the cap 210 is inserted onto the body 208.

The body 208 is constructed from a solid material, such as plastic or metal (or combinations thereof), or from ceramics, including zirconia ceramics. Various negative spaces are formed in the body 208, including a mounting section 216 configured to receive the dynamic driver 206. A sound-transmitting end 218 of the dynamic driver 206 can abut a bottom portion of the mounting section 216, where the mounting section can be in the form of a well having a wider section 220 that abuts the lateral sides 222 of the dynamic driver, and a narrower section 224 that abuts the sound transmitting end 218 of the dynamic driver.

The bottom of the mounting section 216 opens into a sound chamber 228 that in turn is connected to a main sound bore 230 that passes through the body 208 to an exit port 284 (FIG. 2B) at the first end 212. The sound chamber 228 and the main sound bore 230 represent negative spaces in the body 208, and can be formed during production of the body, such as via an injection molding or by 3D printing (including when plastics or ceramics are used for the body 208). The body 208 also includes a pressure relief vent 234 that extends from an upper surface 236 of the body to an exit port 286 at the first end 212 (FIG. 2B).

The cap 210 and the body 208 can include mating negative spaces 240, 242 for receiving a cable socket 244. Cables, or other wiring, not shown, can be connected to the cable socket 244, which in turn is electrically coupled (e.g., via wires) to the dynamic driver 206. The cap 210 further defines a negative space in the form of a recess 250 for receiving an upper end 252 of the dynamic driver 206. The upper end 252 of the dynamic driver 206 can have a narrower cross sectional width than the sound transmitting end 218. The side walls 256 of the recess 250 can be configured to be inserted into a gap between the walls of the mounting section 216 and the lateral sides of the upper end of the dynamic driver 206.

The cap 210 can include a vent bore 260 that extends through the body of the cap to a lateral side 262 of the cap, and which can mate with the pressure relief vent 234. The vent bore 260 can also extend to, and open into, the recess 250 of the cap 210.

An earphone 204 can be constructed by arranging representations of the dynamic driver 206, cable socket 244, sound chamber 228, main sound bore 230, and relief vent 234 in a virtual model of the earphone. The representations can be negative space representations, or can be subtracted from a volume of the virtual model of the earphone 204 to create corresponding negative spaces. The cap 210 can be created in a similar manner. Once the models of the body 208 and the cap 210 have been created, they can be used to create the physical body and cap, such as via 3D printing or injection molding.

The dynamic driver 206 can be inserted into the mounting section 216, and electrically connected to the cable socket 244. The cap 210 can then be placed over the dynamic driver 206 and the cable socket 244, such that the sides 256 of the recess 250 are inserted around the upper end 252 of the dynamic driver. The cap 210 can be further secured by using an adhesive (such as a rubberized adhesive), or other fastening means, such as screws. A faceplate 270 can be coupled to the first end 212 of the body 208.

FIG. 2B presents an exploded view of the earphone 204. The body 208 is shown in a generalized fashion (e.g., a cube), as the disclosed technology is not necessarily limited to any particular body shape. The body 208 is shown as including a negative space 280. The negative space 280 can be represented in a virtual model as negative space 282. That is, removing negative space 282 from a virtual model of a solid earphone body results in the earphone body 208 having the negative space 280. As described above, the negative space 282 can include the sound chamber 228, the sound bore 230, the vent 234, the dynamic driver 206, and at least a portion of the cable socket 244. Additional views of the negative space 282 are provided in FIGS. 2C and 2D.

In FIG. 2B, the body 208 is shown with the exit port 284 for the sound bore 230 and the exit port 286 for the vent 234. The negative space representation 282 shows wells 288 for receiving threaded screw inserts 290, which can receive screws 292 inserted through openings 294 in the cap 210.

An acoustic damper 296 can be inserted within the vent bore 260 (e.g., the vertical portion that mates with the vent 234). An end cap 299, having an opening 298 to the vent bore 260, can be placed over the cable socket 244, and secured to the cap 210.

FIG. 2E illustrates a side view of the body 208 and the cap 210, while FIG. 2F illustrates a cross-sectional view of the body and cap taken along line C-C of FIG. 2E. In FIG. 2E, the driver 206 is shown within the mounting section 216.

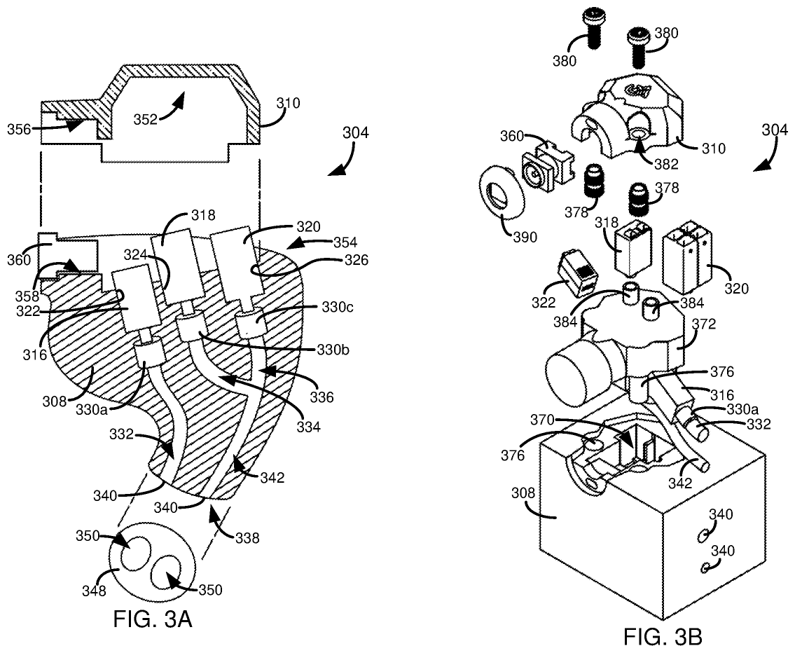

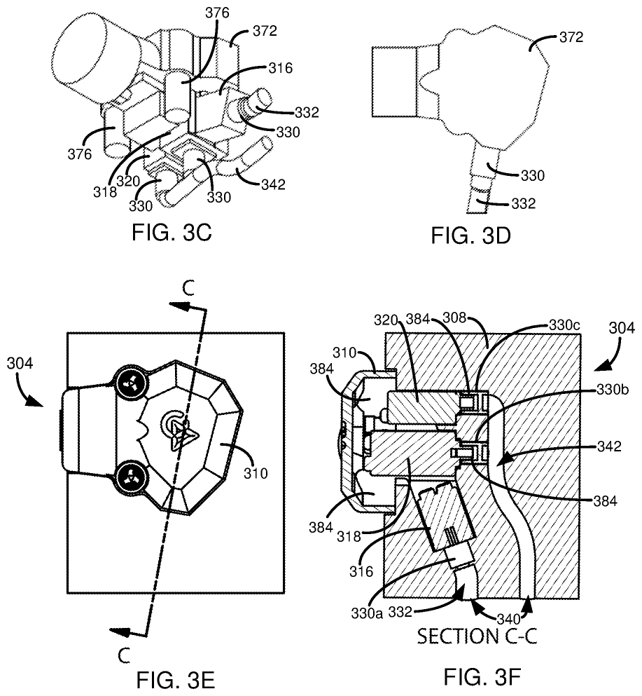

FIGS. 3A-3F illustrate an earphone 304 having a plurality of balanced armature drivers 316, 318, 320 instead of the dynamic driver 206 of FIG. 2A. With reference first to FIG. 3A, the earphone 304 includes a body 308 and a cap 310. The body 308 is constructed from a solid material, such as plastic or metal (or combinations thereof), or from ceramics, including zirconia ceramics, and can be formed using methods such as 3D printing (including when the body is made from plastic or ceramic materials) or injection molding.

The body 308 defines a plurality of negative spaces, in the form of recessed portions 322, 324, 326 that are dimensioned to receive and secure first longitudinal ends of the respective balanced armature drivers 316, 318, 320. The recessed portions 322, 324, 326 can result from modeling the first longitudinal ends of the balanced armature drivers 316, 318, 320 as negative spaces, or subtracting representations of the balanced armature drivers from a virtual model of the body 308.

The balanced armature drivers 316, 318, 320 are positioned next to (e.g., abutting) sound modification or transmission features formed as negative spaces in the body 308. In particular, each balanced armature driver 316, 318, 320 is positioned next to a sound chamber 330 (shown as sound chambers 330a, 330b, 330c). The sound chambers 330 can represent a larger diameter space compared with respective sound bores 332, 334, 336 that extend from lower ends (e.g., towards a first end 338 of the body 308, which end is configured to be placed in a user's ear) of the respective sound chamber, through the body 308 to the first end and a respective exit port 340. The sound chambers 330 can be used, in some cases, to cause resonance in acoustic waves produced by the balanced armature drivers 316, 318, 320. For example, sound chamber 330a can function as a Helmholtz resonator.

Note that the sound bore 334 and the sound bore 336 intersect to end at a common sound bore 342, having an exit port 340. Coupling sound bores 334 and 336 can be used to adjust to audio qualities of the earphone 304, including to adjust resonance properties, in a similar manner as the sound chambers 330.

A faceplate 348 can be placed over the first end 338, where the faceplate has openings 350 configured to be located over the exit ports 340.

The cap 310 defines a recess 352 that is configured to fit over the second longitudinal ends of the balanced armature drivers 316, 318, 320, which extend towards a second end 354 of the body 308. The cap 310 and the body 308 can include mating negative spaces 356, 358 for receiving a cable socket 360. Cables, or other wiring, not shown, can be connected to the cable socket 360, which in turn is electrically coupled (e.g., via wires) to the balanced armature drivers 316, 318, 320.

An earphone 304 can be constructed by arranging representations of the balanced armature drives 316, 318, 320, cable socket 360, sound bores 332, 334, 336 and sound chambers 330 in a virtual model of the earphone. The representations can be negative space representations, or can be subtracted from a volume of the virtual model of the earphone 304 (e.g., the body 308, and optionally the cap 310) to create corresponding negative spaces. The cap 310 can be created in a similar manner. Once the models of body 308 and the cap 310 have been created, they can be used to create the physical body and cap, such as via 3D printing or injection molding.

The balanced armature drivers 316, 318, 320 can be inserted into their respective recesses 322, 324, 326, and coupled to the cable socket 360. The cap 310 can then be placed over the balanced armature drivers 316, 318, 320 and the cable socket 360, such that the upper longitudinal ends of the balanced armature drivers are within the recess 352. The cap 310 can be further secured by using an adhesive, or other fastening means, such as screws. The faceplate 348 can be coupled to the first end 338 of the body 308.

FIG. 3B presents an exploded view of the earphone 304. The body 308 is shown in a generalized fashion (e.g., a cube), as the disclosed technology is not necessarily limited to any particular body shape. The body 308 is shown as including a negative space 370. The negative space 370 can be represented in a virtual model as negative space 372. That is, removing negative space 372 from a virtual model of the solid earphone body 308 results in the earphone body having the negative space 370. As described above, the negative space 372 can include the sound bores 332, 334, 336, the sound chambers 330, the balanced armature drivers 316, 318, 320, and at least a portion of the cable socket 360. Additional views of the negative space 372 are provided in FIGS. 3C and 3D.

In FIG. 3B, the negative space representation 372 shows wells 376 for receiving threaded screw inserts 378, which can receive screws 380 inserted through openings 382 in the cap 310. Acoustic dampers 384 can be inserted in the sound chambers 330b, 330c, as best shown in FIG. 3F. An end cap 390 can be placed over the cable socket 360, and secured to the cap 310.

In general, it is noted that the acoustic properties of a particular earphone can be tuned by incorporating different tuning elements into an earphone body (including different combinations of tuning elements, and tuning elements properties), and by adjusting the properties of the tuning elements (e.g., the length, diameter, and conformation of sound bores and vents, the shape and size of sound chambers). Combinations of tuning elements can include placing acoustic dampers proximate other tuning elements, such as sound bores or vents, including placing acoustic dampers within the path/length of a sound bore or vent.

FIG. 3E illustrates a side view of the body 308 and cap 310, while FIG. 3F illustrates a cross-sectional view of the body and cap taken along line C-C of FIG. 3E. In FIG. 3E, the balanced armature drivers 316, 318, 320 are shown within their respective recesses 322, 324, 326.

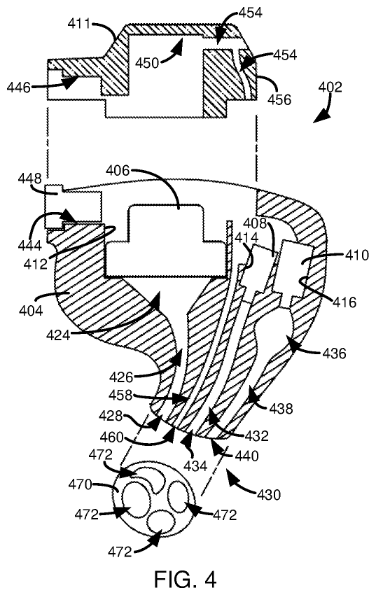

FIG. 4 illustrates an earphone 402 that includes a dynamic driver 406 and two balanced armature drivers 408, 410. The earphone 402 can be formed from a cap 411 and a body 404. The body 404 is constructed from a solid material, such as plastic or metal (or combinations thereof), or from ceramics, including zirconia ceramics, and can be formed using methods such as 3D printing (including when the body is made from plastic or ceramic materials) or injection molding.

The body 404 can have negative spaces, in the form of recesses 412, 414, 416, for receiving the dynamic driver 406 and the balanced armature drivers 408, 410, respectively. The recess 412, for the dynamic driver 406, can be at least generally similar to the recess 216 of FIG. 2. The recesses 414, 416, for the balanced armature drivers 408, 410, can be at least generally similar to the recesses 324, 326 of FIG. 3.

The recess 412 communicates with a funnel-shaped sound chamber 424, which in turn communicates with a sound bore 426 that passes through the body 404 to an exit port 428 at a first end 430 of the body. The balanced armature driver 408 communicates with a sound bore 432 that passes through the body 404 to an exit port 434, while the balanced armature driver 410 communicates with a sound chamber 436 that in turn communicates with a sound bore 438 that passes through the body to an exit port 440.

The cap 411 and the body 404 can include mating negative spaces 446, 444 for receiving a cable socket 448. Cables, or other wiring, not shown, can be connected to the cable socket 448, which in turn is electrically coupled (e.g., via wires) to the dynamic driver 406 and the balanced armature drivers 408, 410.

The cap 411 further defines a negative space in the form of a recess 450 for receiving an upper end of the dynamic driver 406, in similar manner as described for the cap 210 of FIG. 2. The cap 411 can include a vent bore 454 that extends to a lateral side 456 of the cap 411, and which can mate with a pressure relief vent 458 that is formed in the body 404 and extends through the body to an exit port 460. The vent bore 454 can also extend to, and open into, the recess 450 of the cap 411.

An earphone 402 can be constructed by arranging representations of the dynamic driver 406, balanced armature drivers 408, 410, cable socket 448, sound bores 426, 432, 438, sound chambers 424, 436, and relief vent 458 in a virtual model of the earphone. The representations can be negative space representations, or can be subtracted from a volume of the virtual model of the earphone 402 to create corresponding negative spaces. The cap 411 can be created in a similar manner. Once the models of body 404 and the cap 411 have been created, they can be used to create the physical body and cap, such as via 3D printing or injection molding.

The dynamic driver 406 can be inserted into the mounting recess 412, and electrically connected to the cable socket 448. The balanced armature drivers 408, 410 can be inserted into their respective mounting recesses 414, 416 and electrically connected to the cable socket 448. The cap 411 can then be placed over the dynamic driver 406 and the cable socket 448, such that the sides of the recess 450 surround the upper end of the dynamic driver. The cap 411 can be further secured by using an adhesive, or other fastening means, such as screws. A faceplate 470 can be coupled to the first end 430 of the body 404, and can include apertures 472 for communicating with the exit ports 428, 434, 440, 460.

In some implementations, a spout (such as an elongated, optionally tapered structure) configured to be placed into a user's ear, including when covered by a tip (e.g., a plastic or rubber material), can be used instead of, or in addition to, the faceplate 470. The spout can be integrally formed at the first end 430 of the earphone body 404, or can be coupled to the first end (e.g., by snap or friction fit, thermal means, such as welding, or using an adhesive). Although described with respect to the earphone 402, a spout may also be included in other earphone designs, including the earphone 204 or the earphone 304.

### Example 4—Example Manufacturing Method

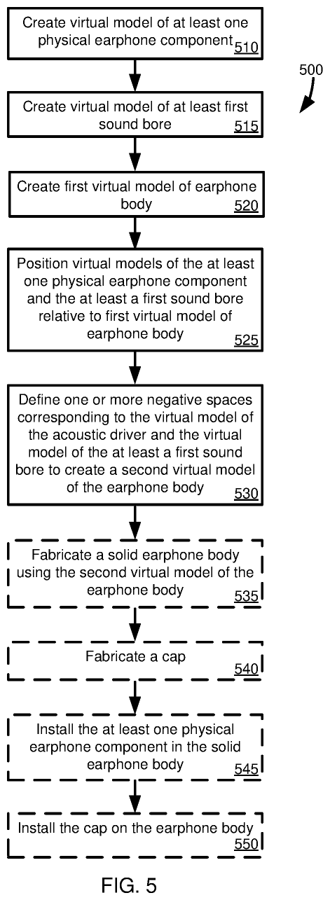

FIG. 5 presents a flowchart of an example method 500 for manufacturing an earphone. At 510, a virtual model of at least one physical earphone component is created. The at least one physical earphone component can be, for example, an acoustic driver (such as a balanced armature driver or a dynamic driver), a cable socket, screw mounts/inserts, or acoustic dampers. A virtual model of at least a first sound bore is created at 515. At 520, a first virtual model of an earphone body is created, such as from a mold of a user's ear, from a 3D scan of a user's ear, from a 3D scan of an earphone body, or by another method. The virtual model of the at least one physical earphone component and the virtual model of the at least a first sound bore are positioned, at 525, at least partially within the first virtual model of the earphone body. At 530, one or more negative spaces are defined in the first virtual model of the earphone body corresponding to the virtual model of the at least one physical earphone component and the virtual model of the at least a first sound bore to create a second virtual model of the earphone body.

The method 500 can optionally include one or more additional steps. For example, at 535, a solid earphone body can be fabricated from the second virtual model of the earphone body, such by 3D printing or injection molding. A cap, to be placed over at least part of a portion of the earphone body, can be fabricated at 540, such as by machining, molding, or 3D printing. At 545, the at least one physical earphone component can be installed in the earphone body, such as in a recess corresponding to a negative space in the virtual model corresponding to the virtual model of the at least one physical earphone component. The cap can be installed on the earphone body at 550.

### Example 5—Example Earphone with Radially-Vented Acoustic Driver

In an embodiment, the present disclosure provides an in-ear earphone having a vent radially disposed about one or more acoustic drivers. Earphones by their nature are small devices, and can have quite small air volumes between earphone components, such as between acoustic drivers when an earphone includes multiple acoustic drivers. Including a radial vent about one or more acoustic drivers can provide a number of benefits, including providing a different/improved sound stage (i.e., acoustically the sounds appear to be present in a larger area/space) and providing greater flexibility in positioning acoustic drivers in an earphone body (e.g., because of the radial vent, an acoustic driver need not be positioned to directly output sound in a particular direction, such as outputting sound through a pathway that is relatively in line with a user's ear canal). The added flexibility in positioning acoustic drivers can provide more design options, and can enable earphones to be made be made smaller in size. In some cases, a sound-emitting end of an acoustic driver can be between 45 degrees and 90 degrees of an axis of a sound-transmitting pathway in an earphone body.

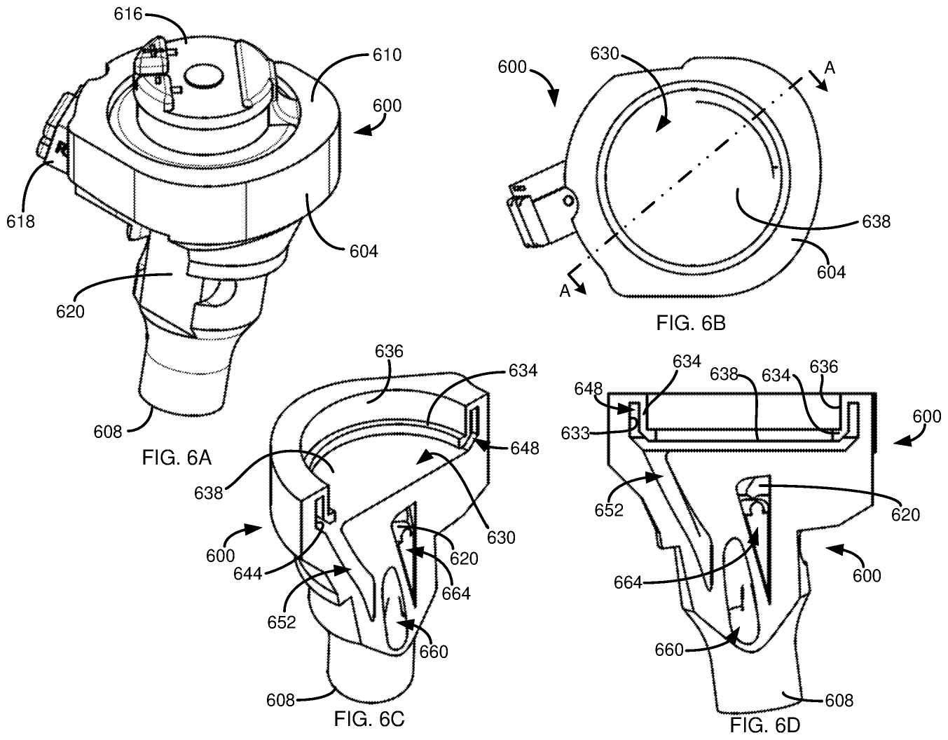

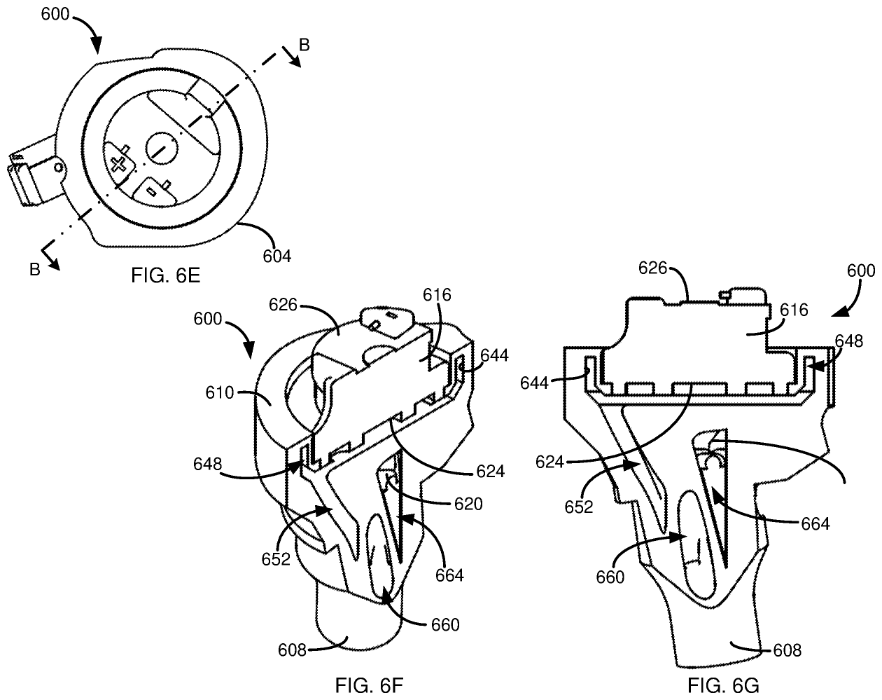

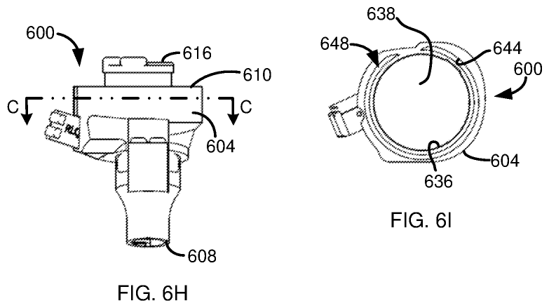

FIGS. 6A-6I illustrate a particular design for an earphone 600 that includes an earphone body 604 having a radial vent (which can also be referred to as a radial port or a radial resonator). FIG. 6A is a perspective view of the earphone 600, where the earphone body 604 has a first end 608 configured to be placed in a user's ear canal and a second end 610 distal (or opposed) to the first end, where the second end is directed outwardly from the user's ear when in use. The earphone 600 can include a plurality of acoustic drivers, including a dynamic driver 616 and balanced armature drivers 618 (which in some cases can be a mid-range driver) and 620 (which in some cases can be a high-range driver).

FIG. 6B is a top plan view of the earphone 600, with the dynamic driver 616 removed, looking at the second end 610 of the earphone body 604. Different views of a cross-section taken along line A-A of FIG. 6B are shown in FIGS. 6C and 6D, where FIG. 6C is a perspective view of the earphone 600 and FIG. 6D is an elevational view of the earphone. FIGS. 6E-6G are similar to FIGS. 6B-6D, but show the earphone 600 with the dynamic driver 616 installed. With reference first to FIGS. 6A, 6F, and 6G, the dynamic driver 616 is at least partially disposed within the earphone body 604, where a first, sound-emitting, end 624 of the dynamic driver is directed towards the first end 608 and an opposing second end 626 of the dynamic driver extends axially from the second end 610.

With reference now to FIGS. 6B-6D, the second end 610 of the earphone body 604 defines an annular cavity 630 configured to receive the dynamic driver 616. An annular ridge or ledge 634 extends about an inner surface 636 of the annular cavity and is configured to maintain the first end 624 of the dynamic driver 616 in a spaced-apart relationship from an axial outer surface 638 of the earphone body (forming a portion of the second end 610 of the earphone body 604). Maintaining an airspace between the first end 624 of the dynamic driver 616 and the outer surface 638 can assist in proper operation of the dynamic driver (e.g., so that the diaphragm of the dynamic driver can move surrounding air to produce sound waves).

At least a portion of the inner surface 636 of the earphone body 604, forming the radial sides of the annular cavity 630, is spaced apart from an annular interior surface 644 of the earphone body, forming a hollow annular chamber, or slot, 648 that is fluidly connected to the annular cavity 630, as at least a portion of the annular cavity extends below the annular ridge or ledge 634 and communicates with the hollow annular chamber. The hollow annular chamber 648 allows an increased volume of air to communicate with the dynamic driver 616, which can improve the acoustic performance of the dynamic driver, provide greater flexibility in positioning the dynamic driver, and enable the earphone 600 to be made smaller (for example, as compared with increasing a distance between the first end 624 of the dynamic driver and the outer surface 638 of the earphone body 604).

The hollow annular chamber 648 further communicates with a longitudinal port 652 (or sound bore) that in turn communicates with a lumen (not shown) formed in the first end 608 of the earphone body, allowing acoustic waves to be transmitted to a user's ear. Any additional drivers included in an earphone, such as the balanced armature drivers 618, 620 of the earphone 600, can be in communication with the lumen that communicates with the dynamic driver 616 or one or more other lumens (which can correspond to sound tubes or sound bores) of the first end 608 of the earphone body 604.

The dimensions of components of the earphone 600 can be adjusted to provide different volumes for the hollow inner chamber 648, which can be used to tune the acoustic properties of the earphone. In various examples, components of the earphone 600 (for example, one or more of the thickness of walls forming the hollow inner chamber 648, the distance between the radial inner surface 636 and the annular interior surface 644, or the axial length of the hollow inner chamber) provide a volume for the hollower inner chamber 648 that is at least 5% of the volume of the space between the first end 624 of the dynamic driver 616 and the outer surface 638, such as being at least 10%, 15%, 20%, or 25% of such space, but in some cases in no more than 75% of such space. For example, the volume of the hollow inner chamber 648 can be between about 15% and about 75%, between about 25% and about 65%, or between about 35% and about 55% of the volume of the space between the first end 624 of the dynamic driver 616 and the outer surface 638. In another example, the volume of the hollow inner chamber 648 can be between 15% and 75%, between 25% and 65%, or between 35% and 55% of the volume of the space between the first end 624 of the dynamic driver 616 and the outer surface 638.

With reference to FIGS. 6C and 6D, the earphone body 604 can define one more sound bores for carrying sound from an acoustic driver through the first end 608 and to a user's ear. In particular, a sound bore 660 is in communication with the dynamic driver 618 and a sound bore 664 is in communication with the dynamic driver 620. The various sound bores 652 (the longitudinal port), 660, 664 can lead to separate openings in the first end 608 of the earphone body, or one or more of the sound tubes can converge and exit the earphone body in a common opening.

FIGS. 6H and 6I are analogous to FIGS. 6A and 6B, but show the dynamic driver 616 installed in the earphone 600.

### Example 6—Example Earphone With Radial Venting for Multiple Acoustic Drivers

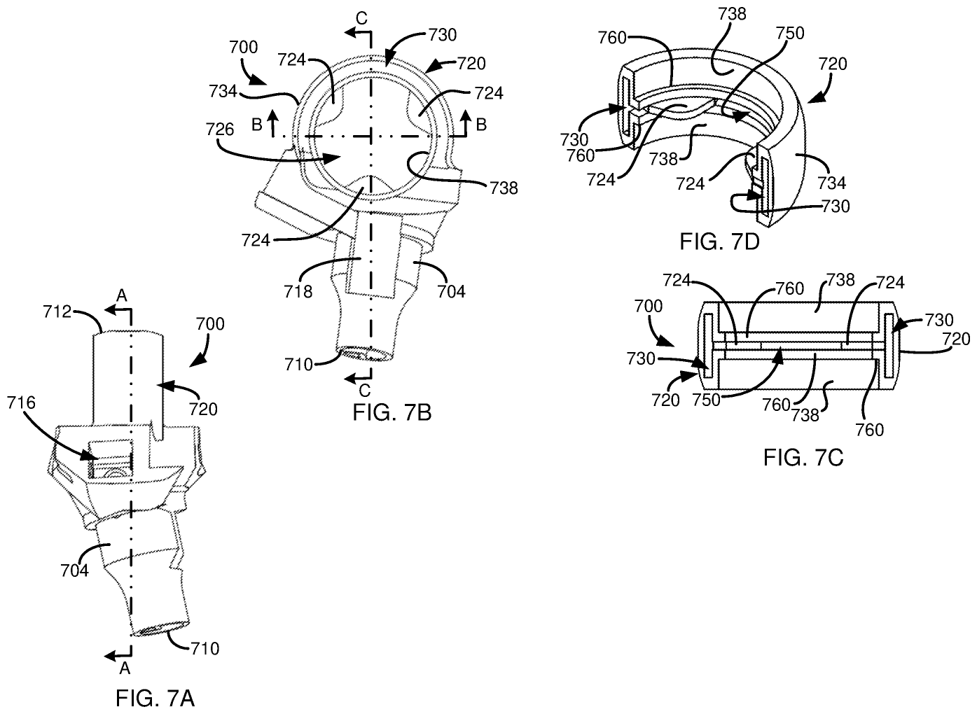

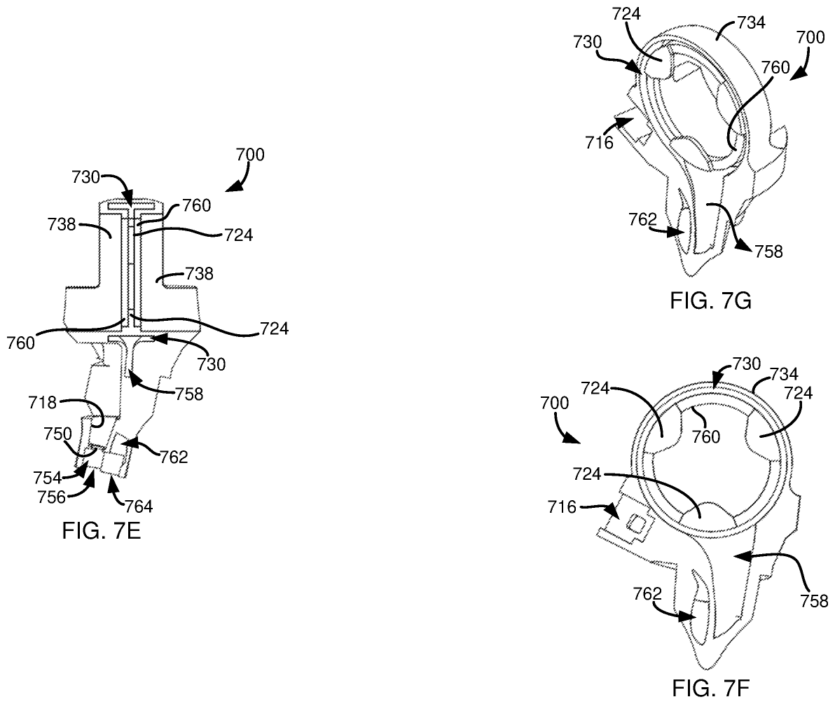

FIGS. 7A-7G illustrate an alternative embodiment of an earphone 700 having radial vent surrounding an acoustic driver. The earphone 700 is generally similar to the earphone 600, however, the earphone 700 is adapted to have radial vents for two dynamic drivers, and a chamber for receiving the dynamic drivers includes standoffs to help maintain the dynamic drivers in a desired position. However, an earphone 700 that includes multiple drivers can use other (or additional) ways of positioning the multiple drivers, such as the ridges of the earphone 600. Similarly, the earphone 600 can use standoffs or other spacing means instead of, or in addition to, the ridges.

FIG. 7A is a perspective view of the earphone 700, showing a body 704 of the earphone having a first end 710 and a second end 712 distal (or opposed) to the first end. The first end 710 is adapted to be placed in the ear canal of a user to transmit sound from the earphone 700. The earphone body 704 further defines a compartment 716 for receiving a balanced armature driver (not shown in FIG. 7A, which in some cases can be a mid-range driver) and a housing 720 for containing two dynamic drivers (not shown in FIG. 7A).

FIG. 7B is a perspective view of the earphone 700, being a cross-section along the line A-A shown in FIG. 7A and rotated 90 degrees about the line A-A. The earphone 700 is shown as including a compartment 718 for an additional balanced armature (not shown, which in some cases can be a high-range driver).

FIG. 7B illustrates the housing 720 without dynamic drivers installed. One dynamic driver can be installed into the face of the housing 720, where it abuts three standoffs or tabs 724 extending radially into a hollow interior portion 726 of the housing 720 from the lateral sides of the housing. Another dynamic driver can be installed into a face of the housing 720 located on the opposing side of the earphone 700, where it will abut the other side of the standoffs 724. The standoffs 724 can be dimensioned (e.g., can have a thickness) that maintains the dynamic drivers at a desired distance from one another, such as to control a volume of air present between the dynamic drivers. In further examples, more than one set of standoffs can be used, such as having a set of standoffs for each dynamic driver. Or one dynamic driver can use standoffs and another can use another positioning means, such as ridges.

A circumferential hollow slot 730 is defined in the housing 720 by an outer surface 734 of the housing and an inner surface 738 of the housing, where the inner surface of the housing defines the hollow interior portion 726. The hollow slot 730 is in fluid communication with the interior portion 726 of the housing 720 along at least a portion of the circumference of the inner surface 738 of the housing 720. That is, apertures (not shown in FIG. 7B) formed along at least a portion of the inner surface 738 of the housing allow fluid (e.g., air), to pass between the interior portion 726 of the housing and the hollow slot 730, and to other portions of the earphone 700, as will be further described.

FIGS. 7C and 7D are cross-sectional views of the earphone 700 taken along line B-B of FIG. 7B, where FIG. 7C is a side elevational cross-sectional view and FIG. 7D is a perspective cross-sectional view. FIGS. 7C and 7D further illustrate the hollow slot 730 formed in the housing 720, where the hollow slot is in fluid communication with the hollow interior portion 726 of the housing through one or more circumferential apertures 750 formed in the housing (best seen in FIG. 7D). As shown, the circumferential apertures 750 are formed between the standoffs 724. In other implementations, the number of circumferential apertures 750 can be modified, such as by increasing or decreasing the number of standoffs 724 or changing the dimensions of the standoffs (e.g., making them circumferentially narrower or sider).

FIG. 7D also illustrates ridges 760 that are formed by portions of the inner surface 738 of the housing 720 which extend radially inwardly to a greater extent than distal portions of the housing. As described with respect to the earphone, 600, the ridges 760 help maintain the position of the dynamic drivers with respect to one another and with respect to components of the earphone body 704. The dynamic drivers can be retained within the housing 720 by various means, including physical retaining structures (e.g., inserting the drivers into a slot), friction fit, or through the use of an adhesive.

FIG. 7E is a cross-sectional elevational view of the earphone 700 taken along line C-C of FIG. 7B, and depicts how the earphone body 704 defines the interior portions 726, which form sockets or compartments for receiving dynamic drivers. The dynamic drivers are maintained in position with respect to one another by the standoffs 724. With the dynamic drivers installed in interior portions, an air gap remains (the portion between the sound emitting face of the dynamic driver and the sound emitting face of the opposed dynamic driver), which is in communication with the circumferential apertures 734 and in turn the hollow slot 730.

FIG. 7E illustrates the interior of the compartment 718 for the balanced armature driver. The compartment 718 is in communication with a baffle 750, which in turn connects with a sound bore 754 that exists through an opening 756 formed in the first end 710 of the earphone body 704. The sound bore 754 can also be configured to receive sound from the balanced drivers, being in communication with a longitudinal exit port 758 that communicates with the hollow slot 730. In other cases, the longitudinal exit port 758 communicates with an opening separate from the opening 756, or the opening 756 can communicate with additional acoustic drivers. For example, the opening 756 optionally can communicate with a sound bore 758 for a dynamic driver placed in an interior portion 726, rather than having such sound bore communicate with a separate exit 764 as shown in FIG. 7E.

FIGS. 7F and 7G are cross-sectional views of the earphone 700 taken along the line A-A of FIG. 7A, where FIG. 7F is an elevational view and FIG. 7G is a perspective view. FIGS. 7F and 7G illustrate an interior portion 726, or socket, for receiving the balanced armature driver. FIGS. 7F and 7G also illustrate a sound bore 762 that communicates with the compartment 716.

### Example 7—Example Earphone With Acoustic Drivers Congruently Disposed About an Axis

Designing earphones with different types and arrangements of acoustic drivers is of interest, as these parameters can affect the number and types of acoustic drivers that can be included in an earphone, and can affect the acoustic properties of the earphone. That is, even if the same number and types of acoustic drivers are included in an earphone, how such drivers are arranged with respect to an earphone body, including with respect to an earpiece configured to be inserted into a user's ear, can affect the acoustic properties of the earphone, including the frequency response and the soundstage provided by the earphone. Typically, when multiple acoustic drivers are included in an earphone, they are arranged on a single plane, and have their sound emitting facing an earphone opening, or at least facing an acoustic path pointing (directly/substantially linearly) towards the earpiece/tip of the earphone. Including multiple acoustic drivers in a earphone can complicate their design, including arranging acoustic drivers in a way that reduces magnetic interference between the acoustic drivers.

The present disclosure provides earphones defining an axis about which a plurality of acoustic drivers are congruently (regularly) distributed. In at least some implementations, the sound producing ends or faces of the acoustic drivers are directed inwardly towards the central axis, and sound from the acoustic drivers is directed to a cavity formed along the axis. At least certain disclosed embodiments provide earphones where acoustic drivers are disposed in multiple planes or which are disposed such that their output is not directly in line with an earpiece/tip of the earphone, including in some cases being orthogonal to a line intersecting the face of the earpiece/tip. Disclosed earphones can have bodies or other components that help maintain the acoustic drivers in a desired position, including to prevent movement of the acoustic drivers from such position due to magnetic repulsion between the acoustic drivers.

The disclosed earphones can provide a number of benefits. In particular, disposing the acoustic drivers regularly about an axis can reduce interference (e.g., magnetic interference) between the acoustic drivers, which can provide improve sound quality. Disposing the acoustic drivers about an axis can also allow a larger number of acoustic drivers to be placed within an earphone body, or increase the driver surface area that can be included in a particular earphone volume/form factor. While the number of acoustic drivers arranged about an axis can vary, in more particular implementations the number of acoustic drivers is three or more, and in a particular example that will be described in more detail the number of acoustic drivers is three. In some cases, including the described embodiments, the acoustic drivers are of the same or at least substantially the same size. In other cases, the acoustic drivers arranged about the axis can have different sizes so long as they are congruently or substantially congruently disposed about an axis. In particular, at least one acoustic driver has a different size than at least one other acoustic driver, but the acoustic drivers are disposed congruently or substantially congruently about the axis with respect to the circumferential midpoints of the acoustic drivers.

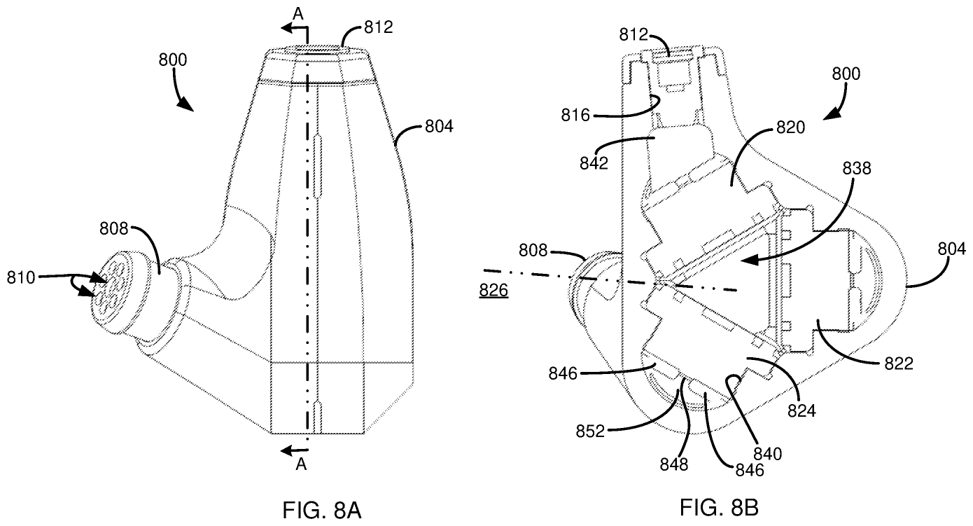

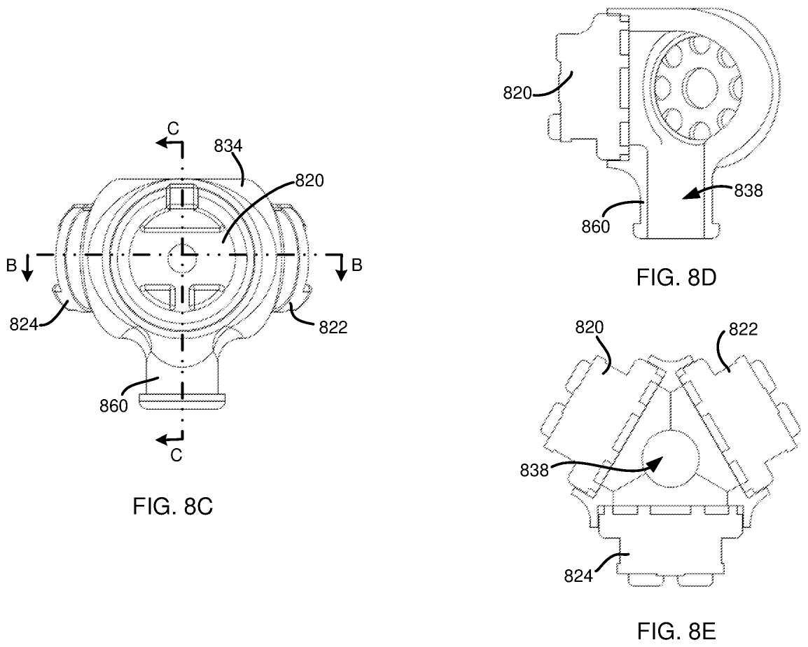

FIGS. 8A-8E are various views of an earphone 800. With reference first to FIG. 8A, the earphone 800 includes an earphone body 804. The earphone body 804 comprises an ear tip 808 configured to be place in a user's ear and to deliver sound through one or more apertures 810 formed in the earphone body. The earphone housing 804 is also shown as containing a first acoustic driver 812, which in a particular implementation can be a balanced armature driver.

FIG. 8B is a cross-sectional view of the earphone 800 taken along line A-A of FIG. 8A. FIG. 8B illustrates the first acoustic driver 812 mounted within a cavity 816 defined in the earphone body 804. Second, third, and fourth acoustic drivers, 820, 822, 824, which can be dynamic drivers in a particular example, are congruently disposed about an axis 826 (i.e., the dynamic drivers are disposed at regular angles about the axis, such that pairs of acoustic drivers are separated by the same, or substantially the same, circumferential distance). The sound emitting faces of the acoustic drivers 820, 822, 824 can be directly inwardly towards the axis 826, which can be a follow area that acts as a tuning chamber or sound bore, and through which sound can travel to reach the user's ear. The earphone body 804 can be constructed from mating halves that are connected after inserting the acoustic drivers 812 and 820-824 within one half of the earphone body, and where the combined features of the halves maintain the acoustic drivers in a desired position.

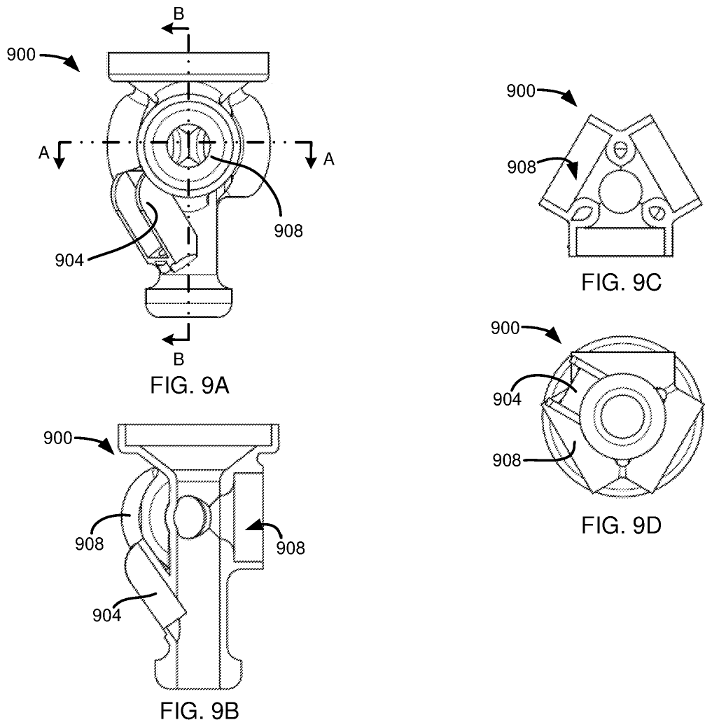

In one embodiment, the acoustic drivers 820, 822, 824 are not mounted directly in the earphone body 804, but rather are mounted in a tuning armature (which can also be referred to as a framework or a mount) 834 (FIGS. 8C-8E and 9A-9D). The turning armature 834, with the acoustic drivers 820, 822, 824 mounted therein, define a generally triangular (equilateral) tuning chamber 838. In practice, the acoustic drivers 820, 822, 824 can be mounted within the tuning armature 834, and the tuning aperture can be inserted into the earphone body 804 where the acoustic drivers are positioned with mounting cavities 840 formed in the interior volume of the earphone body.

FIG. 8B further illustrates a wire compartment 842, which can house wiring that connects to internal components (e.g., one or more of the acoustic drivers 820, 822, 824), or which can be used to connect the earphone 800 to an external source (e.g., an external audio signal to be delivered to the acoustic drivers). Acoustic damper screens 848 are attached to a rear portion of each acoustic driver 820, 822, 824. The acoustic damper screens 848 act as a tuning element that can affect the tonal qualities of the sound produced by the earphone 800. In a particular embodiment, an acoustic material can be cut, such as by laser cutting, and adhered to a frame that is then secured to a respective acoustic driver 820, 822 ,824. In this case, the screen 848 can represent a combined screen and frame. Among other advantages, the use of the frame can assist in securing the screens 848 to the acoustic drivers 820, 822, 824, improving the ease of manufacture of the earphone 800.

Spaces 852 behind respective acoustic drivers 820, 822, 824 can be used for connecting and routing wiring from another location in the earphone 800 to the acoustic drivers. The acoustic drivers 820, 822, 824 can include solder pads 846 for connecting a respective acoustic driver to wiring that delivers electrical signals to the respective driver, where a portion of the wiring can be located in the wire compartment 842.

FIG. 8C is a top plan view of the tuning armature 834, showing the acoustic drivers 820, 822, 824 disposed about the axis 826, which also serves a line C-C for the cross-sectional view provided in FIG. 8E. The tuning armature 834 includes a tubular projection 860 extending coaxially to the axis 826. The tubular projection 860 is in fluid communication with the ear tip 808, and acts as a sound bore to transmit acoustic signals from the cavity 838. That is, in at least some examples the tubular projection 860 does not extend into the cavity 816. The tunning armature 834 can be disposed within a cavity 844 formed in the earphone body (FIG. 8B).

FIGS. 9A-9D are various views of turning armature 900, which can be incorporated into an earphone, such as the earphone 800 or one generally similar thereto. The tuning armature 900 is generally similar to the tuning armature 834, but includes a driver compartment 904, such as for a balanced armature driver, in addition to compartments 908 for other drivers, such as dynamic drivers. The compartments 908 maintain the drivers in a triangular configuration similar to the earphone 800. The compartment 908 illustrates how an earphone design can be adapted to include additional drivers to affect the acoustic properties of the resulting earphone.

### Example 8—General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present, or problems be solved.

Features, integers, characteristics, compounds, chemical moieties, or groups described in conjunction with a particular aspect, embodiment or example of the invention are to be understood to be applicable to any other aspect, embodiment or example described herein unless incompatible therewith. All of the features disclosed in this specification (including any accompanying claims, abstract, and drawings), and/or all of the steps of any method or process so disclosed, may be combined in any combination, except combinations where at least some of such features and/or steps are mutually exclusive. The present disclosure is not restricted to the details of any foregoing embodiments. The present disclosure extends to any novel one, or any novel combination, of the features disclosed in this specification (including any accompanying claims, abstract, and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means physically coupled or linked and does not exclude the presence of intermediate elements between the coupled items absent specific contrary language. “Directly coupled” refers to two components that are directly physically coupled or linked, and excludes the presence of intermediate elements. As used herein, the terms “integrally formed” and “unitary construction” refer to a construction that does not include any welds, fasteners, or other means for securing separately formed pieces of material to each other, or features resulting from securing separately formed pieces, such as joints, seams, or discontinuities of shape or material.

As used herein, “in fluid communication” means that two components are coupled via a common transmission medium, such as a sound transmission medium (e.g., air). Two components can be referred to as in “direct fluid communication” when a transmission medium can flow directly between the two components, such as without passing through intermediate spaces, such as a tube.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. An earphone comprising:
an earphone body;
three or more acoustic drivers disposed in the earphone body and substantially congruently disposed about a central axis;
an acoustic driver, the acoustic driver being one of the three or more acoustic drivers or an acoustic driver that is in addition to the three or more acoustic drivers, having a first, sound emitting, end and a second end opposed to the first end;
a compartment defined in the earphone body or in a component inserted into the earphone body, wherein the acoustic driver is received within the compartment; and
a vent defined in the compartment and coaxial to an axis passing through the first end and the second end of the acoustic driver.

2. An earphone comprising:
an earphone body; and
three or more acoustic drivers disposed in the earphone body and substantially congruently disposed about a central axis.

3. The earphone of claim 2, wherein the three or more acoustic drivers consist of three acoustic drivers.

4. The earphone of claim 3, wherein the three acoustic drivers comprise respective midpoints and the respective midpoints are disposed substantially 120 degrees apart from one another in a circle defined about the central axis and having the central axis as its center.

5. The earphone of claim 3, wherein the three acoustic drivers comprise respective midpoints and the respective midpoints are disposed 120 degrees apart from one another in circle defined about the central axis and having the central axis as its center.

6. The earphone of claim 2, wherein the three or more acoustic drivers are congruently disposed about the central axis.

7. The earphone of claim 2, wherein the three or more acoustic drivers comprise a sound emitting face and the sound emitting faces of the three or more acoustic drivers are directly inwardly toward the central axis.

8. The earphone of claim 2, wherein the three or more acoustic drivers are disposed in a tuning armature.

9. The earphone of claim 8, wherein the tuning armature is separate from the earphone body and is inserted into a chamber formed in the earphone body.

10. The earphone of claim 9, wherein the tuning armature defines a compartment for receiving an additional acoustic driver, the additional acoustic driver not being congruent with the three or more acoustic drivers.

11. The earphone of claim 8, wherein the tuning armature comprises compartments for receiving respective acoustic drivers of the three or more acoustic drivers, the compartments defining a radial slot formed about lateral sides of respective acoustic drivers.

12. An earphone comprising:
an earphone body;
a compartment within the earphone body for receiving an acoustic driver;
an acoustic driver disposed within the compartment comprising a first, sound emitting, end and an opposing second end and lateral sides orthogonal to the first end and the second end; and
a vent defined in the compartment and coaxial to an axis passing through the first end and the second end of the acoustic driver.

13. The earphone of claim 12, where the vent is axially spaced apart from the first end of the acoustic driver along the axis.

14. The earphone of claim 12, the compartment comprising one or more standoffs abutting the acoustic driver, wherein the one or more standoffs assist in maintaining the vent and the acoustic driver in a spaced apart configuration.

15. The earphone of claim 12, wherein the vent does not extend along an inner surface of the compartment coaxial to the axis.

16. The earphone of claim 12, wherein the earphone body defines an earpiece opening into the earphone body and configured to be placed in a user's ear, further comprising:
a sound tube in fluid communication with an opening of the earpiece and the vent.

17. The earphone of claim 12, further comprising an acoustic driver that is not in immediate fluid communication with the vent.

18. The earphone of claim 12, wherein the acoustic driver is a first acoustic driver and the earphone further comprises:
a second acoustic driver having a first, sound emitting, end and an opposing second end, wherein the first end of the first acoustic driver faces the first end of the second acoustic driver and the second acoustic driver is proximate to, and in immediate fluid communication with, the vent.

19. The earphone of claim 12, wherein the acoustic driver is a first acoustic driver, the vent is a first vent, and the earphone further comprises:
a second acoustic driver having a first, sound emitting, end and an opposing second end, wherein the first end of the first acoustic driver faces the first end of the second acoustic driver; and
a second vent defined in the compartment and coaxial to the axis, wherein the first end of the second acoustic driver is proximate to, and in immediate fluid communication with, the second vent.

20. The earphone of claim 19, wherein the first vent is axially spaced apart from the second vent.

21. The earphone of claim 12, the compartment further comprising a ridge extending radially into an interior portion of the compartment and configured to maintain the acoustic driver in given position with respect to the vent.
